(19) United States
(12) Patent Application Publication
(10) Pub. No.: US 2016/0019622 A1
(43) Pub. Date: Jan. 21, 2016

(54) SYSTEM FOR AGGREGATING, COMPARING AND ACQUIRING COLLECTIBLES, METHODS AND USES THEREOF

(71) Applicant: Collectors Universe, Inc., Santa Ana, CA (US)

(72) Inventors: Donald E. Willis, JR., Huntington Beach, CA (US); Miao Chen, Irvine, CA (US); David G. Hall, Coto de Caza, CA (US); John C. Nelson, Laguna Hills, CA (US)

(21) Appl. No.: 14/804,224

(22) Filed: Jul. 20, 2015

Related U.S. Application Data
(63) Continuation-in-part of application No. 14/335,219, filed on Jul. 18, 2014.

(51) Int. Cl. G06Q 30/06

(52) U.S. Cl. CPC G06Q 30/0625; G06Q 30/0641; G06Q 30/0603

(57) ABSTRACT

A system for acquiring and managing collectibles is disclosed and described herein that may include a global collectibles database, a collectibles catalog, and a comparison module. The global collectibles database includes about collectibles for sale from at least two different vendors, auction sites, dealers, trade shows or a combination thereof. The collectibles catalog includes information about known collectibles in existence. The comparison module may be used to compare collectibles for sale with known collectibles and/or collectibles of a collector and available collectibles for sale.

### PRIORITY

This application is a continuation-in-part to U.S. application Ser. No. 14/335,219, filed Jul. 18, 2014, which is incorporated by reference in its entirety into this application.

### BACKGROUND

Collectible items, such as coins, stamps, sports cards, cars, and other memorabilia and objects were sold and acquired through shops, private sales and trade shows until the widespread acceptance and use of the Internet. But even after some collectors and shops moved online, traditional methods of acquiring collectibles remained the primary way to view, purchase and/or trade collectible items. Unfortunately, collectors can (and usually do) spend hours searching the Internet for sets or for items to complete or enhance their collectible sets.

When a collector searches online, that collector may navigate one or more individual known collectable reseller or auction sites. In this case, the collector has to be aware of the sellers before searching their inventory. In performing a general search, the collector can put in search criteria into shopping search engines, such as, for example, Google® shopping. However, the user is at the mercy of the seller to properly describe their inventory or fully describe the product so that it is found based on the search terms entered by the collector. If a seller mischaracterizes their inventory, then a collector will not be able to find the desired items. The sellers may also not fully describe or tag an item completely so that the collector must still sort through a number of irrelevant results to find the specific desired collectable. Therefore, the results presented to a user may be inaccurate, incomplete, overly inclusive, and combinations thereof. In whichever situation, the collector must still spend substantial time searching for the desired collectable and filtering the results for the desired collectible. The collector may also have to broaden their search and review substantially more unwanted results to have a chance of finding more desired collectibles that may be mis-described or under-described. These results may even be missed regardless of the search performed by the collector.

For example, a collector may be looking for an 1875 $20 liberty head coin. When searching in Google® shopping, the collector may enter the string “1875 $20 liberty head coin”, and receive six search results back. The collector may be interested in a specific type of coin, such as a certain mint, grade, or other distinguishing characteristic in order to complete or upgrade a set. However, the collector may not have the ability to search on the characteristic, and must therefore, review substantially more results than is relevant to the collector. The above six results may include, for example, three identified for mints not of interest to the collector and one that is mis-described having a characteristic that does not even exist for the given year. Therefore, of six returned results, only two are viable options for the desired purchase. However, as the collector searches across their collection, the less rare coins may return more prolific results with even more irrelevant, misrepresented, or missed results.

### SUMMARY

A system for acquiring and managing collectibles is disclosed and described. The system may be used to improve the accuracy of the presented results, as well as provide more precise searching options, such that a collector can target a search for a given collectable specific to their needs.

Exemplary embodiments may include a global collectibles database in which available collectibles for sale are stored. The global collectibles database may include structured data fields such that specific information relevant to the type of collectible may be specifically stored and categorized. A collector may then use the global collectibles database to conduct searches for specific collectibles of interest to the collector available for purchase.

Exemplary embodiments may include a collectibles catalog in which all or a subset of known collectibles are stored including available characteristics consistent with select structured data fields of the global collectibles database.

Exemplary embodiments may include a comparison module such that the collectibles catalog may be compared with the global collectibles database to confirm the accuracy of retrieved information before or after being stored in the global collectibles database and/or provide more precise information and/or supplemental information corresponding to the structured data fields of the global collectibles database.

### DRAWING DESCRIPTION

FIG. 1 illustrates a schematic block diagram of the portions of an exemplary embodiment including a system for acquiring and managing collectibles

FIG. 2 illustrates a block diagram of a flow chart representing an exemplary method for acquiring and managing collectibles.

FIGS. 3A & 3B illustrate an exemplary user interface for engaging exemplary embodiments described herein.

FIG. 4 illustrates an exemplary user interface for displaying information from the Global Collectibles Database.

FIG. 5 illustrates an exemplary comparison module interface.

FIGS. 6A and 6B1-6B2 illustrate an exemplary user interface for comparing collections using the comparison module.

FIG. 7 illustrates an exemplary user interface embodiment for the Alert Module that allows the user to set parameters and standards for a particular collectible.

FIG. 8 illustrate exemplary embodiments of the dashboard.

FIG. 9 illustrates an exemplary user interface embodiment of the global collectibles database including “Coins I'm Watching” detail.

FIG. 10A illustrates an exemplary high level configuration of the network, global collectibles database, and collectibles catalog, while FIG. 10B illustrates an exemplary architecture to accomplish the described configuration.

### DESCRIPTION

A system has been developed and is described herein that: a) allows sellers to catalog available collectibles in dealer inventories, auction inventories or a combination thereof on the internet, b) matches online inventories against various set registries and catalogs on the internet, c) creates an index for collectibles buyers, so that they can browse the inventory of a large number of dealers at one time and in one location, d) allows collectors to compare their individual collectibles or sets to other publicly-listed collections, e) allows collectors to set up a “wish list” for items that they want to acquire or add to their collections or collections they want to acquire with the wish list being an alert-based system, f) calculates the value of the user's set or sets and provides information as to the available inventory on the market that can improve the collector's set or sets and by how much, and g) any combination thereof.

FIG. 1 illustrates an exemplary system 100 for acquiring and managing collectibles that comprises: a first subject collectibles database 110, a global collectibles database 120, a collectibles catalog 130, a comparison module 140, a search module 150, and a reporting module 160. In some contemplated embodiments, the system 100 further comprises a sales module or interface 170. In other embodiments, the system further comprises an alert module 180. Each of these databases, catalogs and modules are described in detail herein, along with how they are operatively connected and used.

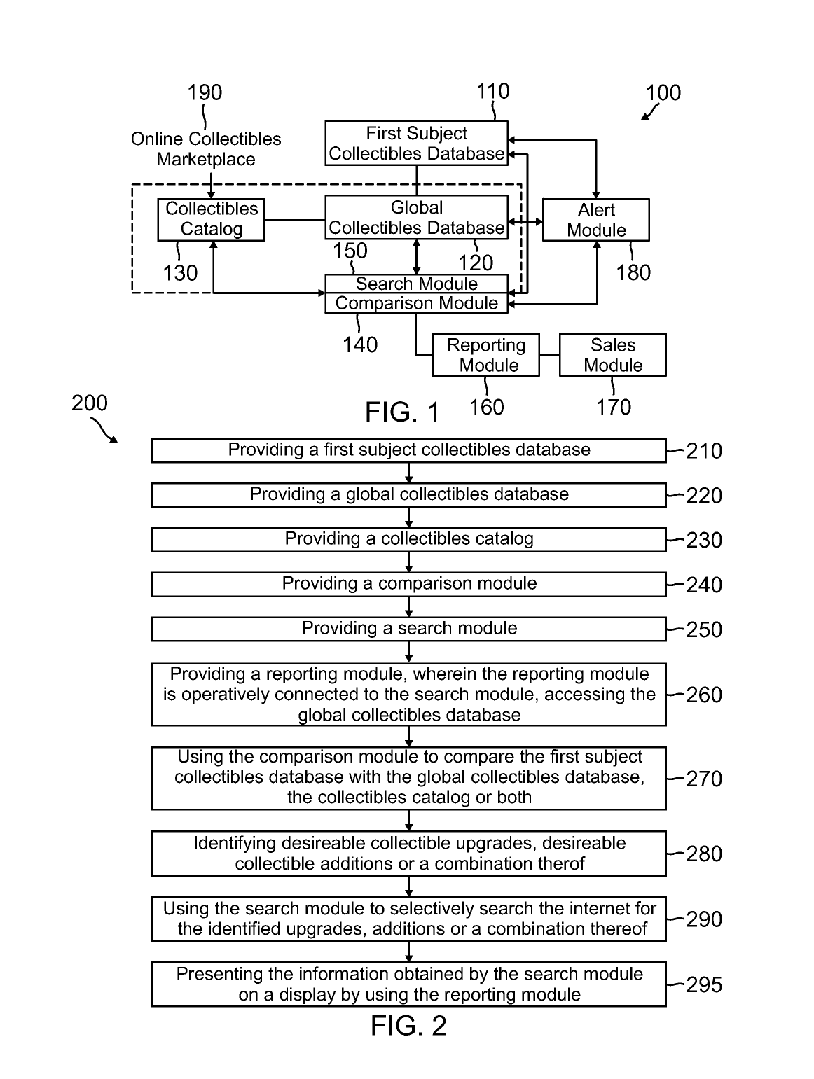

A method 200 for acquiring and managing collectibles is shown in FIG. 2 and includes: providing a first subject collectibles database 210, providing a global collectibles database 220, providing a collectibles catalog 230, providing a comparison module 240, providing a search module 250, providing a reporting module 260, wherein the reporting module is operatively connected to the search module, accessing the global collectibles database, using 270 the comparison module to compare the first subject collectibles database with the global collectibles database, the collectibles catalog or both, identifying 280 desirable collectible upgrades, desirable collectible additions or a combination thereof, using 290 the search module to selectively search the internet for the identified upgrades, additions or a combination thereof, and presenting 295 the information obtained by the search module on a display by using the reporting module.

A separate online collectible marketplace, which may act as a companion or component to the system for acquiring and managing collectibles or may be independent from that system, comprises: a global collectibles database comprising information from at least two different sources, a collectibles catalog and a search module. This contemplated marketplace is distinguished over conventional systems in that the contemplated marketplace “crawls” all available online sources and pulls back relevant information in a format where collectibles from multiple vendors can be compared in an easy and relatable format.

Software applications that can be saved on a smartphone, tablet, computer, the cloud, a global network, or laptop and that can access the systems and methods disclosed herein are also contemplated.

### First Subject Collectibles Database

A contemplated first subject collectibles database is the one or more individual collections of collectibles owned by an individual, trust, entity or company. This database is the electronic collection and representation of identifying information related to a physical collection of collectibles.

For example, a collector may have a set of collectible coins at home in a vault. The identifying information, including type, value, condition and other suitable information, along with a photo, is uploaded to or entered into the first subject collectibles database, which represents what the collector currently has in his or her collection. This information can also be used to compare with other collectors' sets through a set registry, such as the PCGS Set Registry, wherein collectors can register their coin sets, compare their sets with other collectors and compete with other collectors for who has the better coin set. A second, third or subsequent subject collectibles database is contemplated and will be described below in relation to the system.

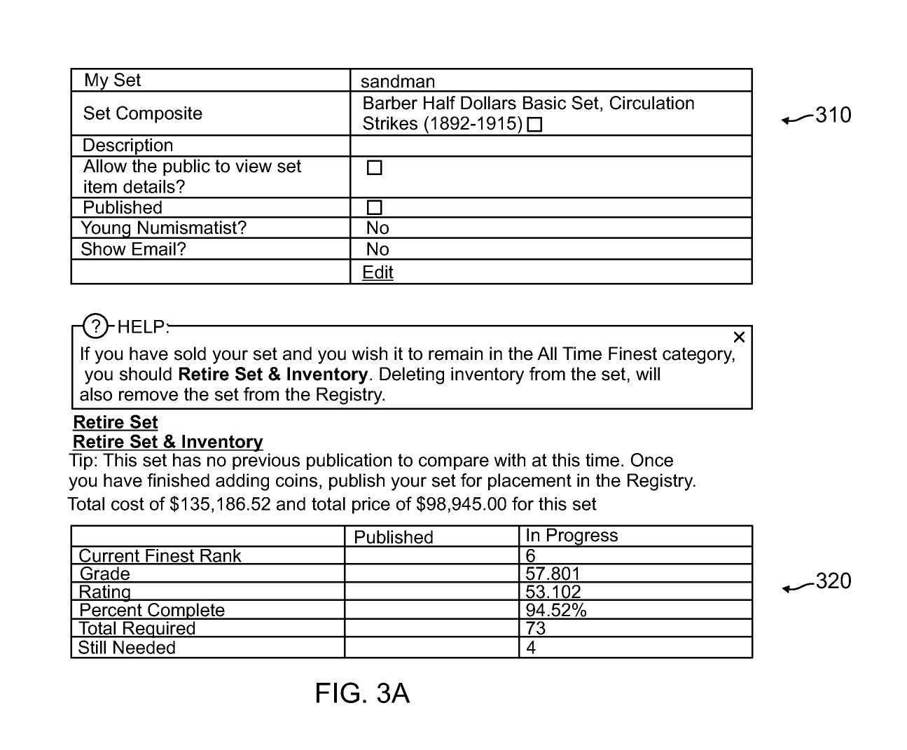

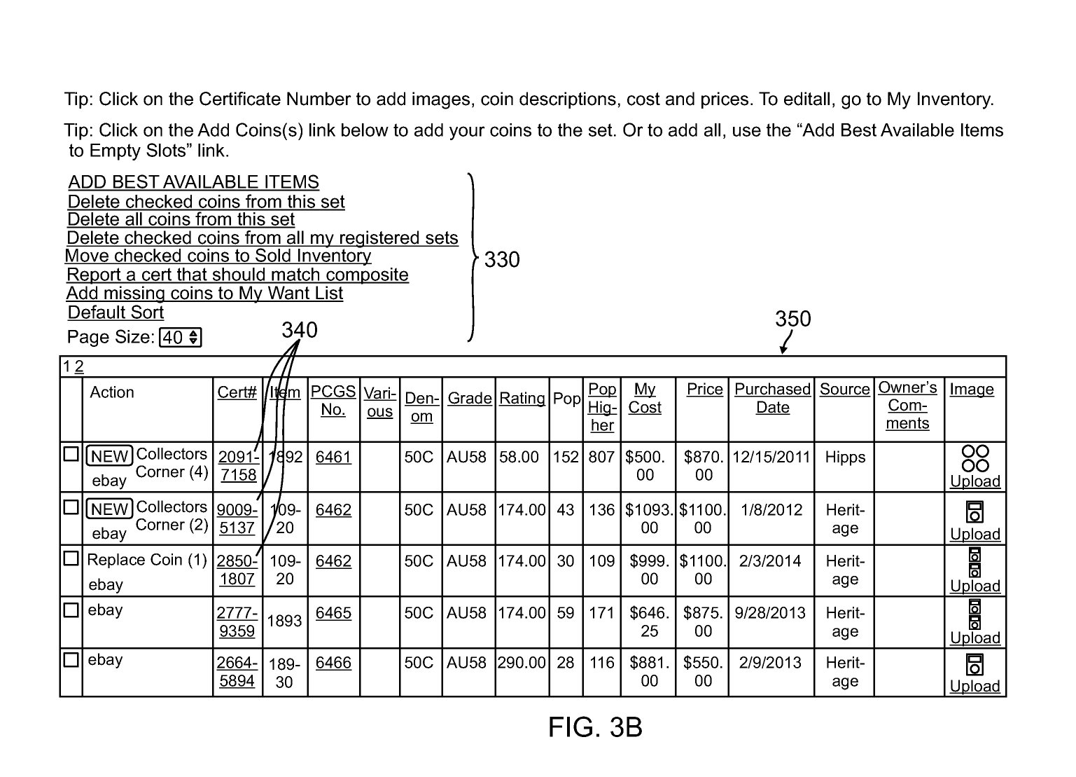

FIG. 3A illustrates an exemplary user interface for displaying information from or related to information contained in the first subject collectibles database. For example, the user interface shows information 310 and 320 for a user's first subject collectibles database at the top of the page, including the rank, the degree of completion, etc. As the user toggles down the page and as shown in FIG. 3B, the user is provided links 330 to “Add Best Available Items”, which will provide information on how to globally update the user's set with any available items in the Global Collectibles Database, Delete or Move Coins within the set, Sell Coins out of the First Subject Collectibles Database or add Missing Coins to the Watch List (“Coins I'm Watching”). The user is then presented with all of the available coins 340 from the Global Collectibles Database 350 that the user may want to view to add to and/or improve his or her set.

### Global Collectibles Database

A global collectibles database is the database of available collectibles for purchase, trade or acquisition. Available collectibles also includes those that are part of online auctions. This database is the electronic collection and representation of identifying information, including digital photos where available, and cost of a group of collectibles. The global collectibles database may include structured data fields specific or related to the type of collectible. For example, coins may include date, denomination, variety, etc., while a playing card may include the player name, year, team, sport, etc.

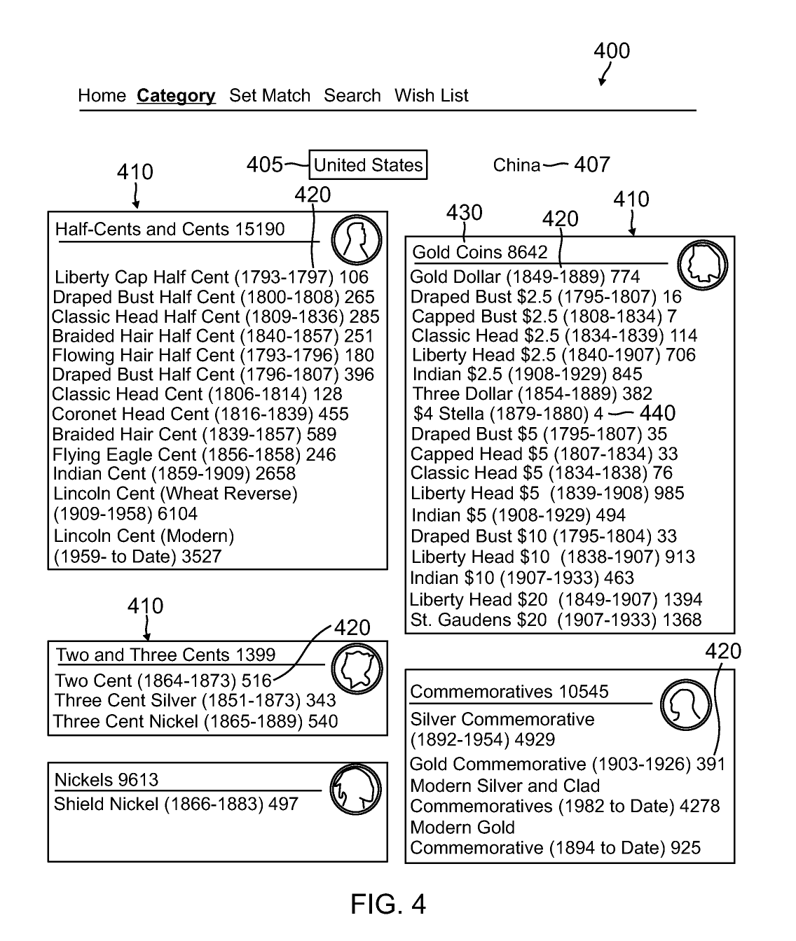

FIG. 4 illustrates an exemplary user interface representing information from a simple global collectibles database 400 where a number of types of coins 410 are shown for the United States 405 (as opposed to China 407), along with a number link 420 that shows how many of that particular type of coin are currently globally available for purchase or acquisition. FIG. 4 shows the Gold Coins grouping 430, if the user clicks on the number link 440 next to the $4 Stella, the four available coins will be shown under the link on the page or in a pop-up image. Note that the four that are found will be shown in more detail, with a digital image (if one is available), the grade, the price, the vendor information, the auction information (if it is an auction), and if it is an auction, the time left. It is also contemplated that the user can click on one of the four items (or multiples) and directly set up alerts using the Alert Module (that is described later herein) or set the item up as a “Coin I'm Watching” on the user's Dashboard.

This contemplated database is updated on a regular basis either at particular and specific time intervals or randomly over a given period of time. This contemplated database is also updated to show when an auction may end or when an item has been sold and is no longer available. In addition, especially when one of the collectibles is being presented as an auction item, the cost or most recent bid may be updated on a shorter timeframe as the end of the auction approaches. So, when the item is first put up for bid, it may be updated every 6 or 8 hours, but as the auction gets closer to the end, the cost or most recent bid is updated every hour, every half hour, every 5 or 10 minutes, or every minute. It should be understood that the term “auction” or “auctions”, as used herein, refers to online or live auctions. For both live and online auctions, it may be that the auction house has set up an online component or a pre-bidding component that is found online. This information will be found by contemplated systems and contained within the global collectibles database, as understood.

### Collectibles Catalog

Contemplated collectibles catalogs are those catalogs that are prepared, and in many instances proprietary, to a company who specializes in collectibles. One example of a contemplated catalog is PCGS Numbering System, which contains information about United States coins and can be found at http://www.pcgs.com/pcgsnolookup/. Contemplated catalogs may be operatively connected as part of the comparison module to both the first subject collectibles database and the global collectibles database. A collector can compare his or her set (first subject collectible database) to the catalog or can compare potential additions (global collectibles database) to his or her set to the catalog.

The collectibles catalog may include structured data fields for a given type of collectible. In an exemplary embodiment, the collectibles catalog is populated with uniquely identifiable collectibles in existence. The uniquely identifiable collectibles may be single individual collectibles such that each individual collectible correlates to one and only one collectible in existence, or the uniquely identifiable collectibles may be a group or class of collectibles where the group or class share the same multiplicity of distinguishable characteristics. For example, a collectibles catalog for coins may include a description, date, denomination, variety, identification number, etc. The structured data fields may be the same or different from those of the global collectibles database.

In an exemplary embodiment, the collectibles catalog includes all known or observed items of the collectible type, individually identified, categorized, and described. The collectibles catalog may comprise information retrieved from or maintained by grading companies and include the descriptions about all of the type of collectible graded by one or more grading company. The collectibles catalog may comprise information retrieved from sales sites, such as the global collectibles database. The collectibles catalog may comprise information retrieved from individual collectors describing or sharing their collections, such as the first collectibles database.

In an exemplary embodiment, the collectibles catalog includes only verified information, in which the descriptions and information contained in the structured data fields are validated before the collectible description is stored in the collectible catalog. For example, items that have been graded may be entered into the collectible catalog as part of or after the grading process. Alternatively, or in addition thereto, the information may be verified, such as using the validation module described herein to retrieve information about the same characteristic of the collectible from more than one source to confirm its accuracy before it is entered into the collectibles database. In an exemplary embodiment, the collectibles in the collectibles catalog may be provided a distinguishable or unique identifier, such that each entry of the collectible catalog represents an individual and unique collectible in physical existence.

### Comparison Module

One of the unique aspects of contemplated embodiments described herein is the comparison module. The comparison module may be used to provide additional accuracy and precision to the information of the global collectibles database. Therefore, a collector searching for a specific item may be able to find it more quickly and confidently.

Once information is retrieved from the site about an available collectible for sale or auction, the comparison module may be used to validate and/or retrieve additional information about the specific collectible, such as by using the collectibles catalog. For example, the comparison module may compare two or more pieces of retrieved information stored in corresponding two or more structured data fields of the global collectibles database (or other intermediary storage location/structure) from an available sale to two or more structured data fields of the collectibles catalog that corresponds to the collectible of the retrieved information. The accuracy of the collectible for sale may therefore be confirmed. If each of the two or more pieces of retrieved information matches the corresponding two or more pieces of information stored in the structured data fields of the collectibles catalog, then the sale item can be included or maintained in the global collectibles database.

For example, once information corresponding to at least two of the structured data fields of the global collectibles database are retrieved or recognized from a seller's site, such as, for a coin example, the date, denomination, grading identifier, and variety, the retrieved information may be compared to the collectibles catalog to confirm the accuracy of the information. If the retrieved information corresponding to two or more of the structured data fields of the collectibles catalog are confirmed as accurate, then the retrieved information may be used to populate the global collectibles database. If a discrepancy is found in the retrieved information, a set of logic rules can be used to either modify the information with corrected information and enter the modified information into the global collectibles database, enter the information without modification into the global collectibles database, enter both options for the discrepant information into the global collectibles database, not enter the information at all or some subset into the global collectibles database, or provide an alert or notice that the information should be verified before or after inclusion in the global collectibles database, and any combination thereof.

In an exemplary embodiment, if a threshold number of retrieved pieces of information corresponding to structured data fields of the global collectibles database are accurate as compared to the corresponding structured data fields of the collectibles catalog, then the information is entered into the global collectibles database, and any retrieved information in conflict with the corresponding information of the collectibles catalog is modified by the information stored in the collectibles catalog. For example, if only one piece of information is found discrepant, but the other two or more pieces are accurate, then the discrepant information may be replaced by the validated information from the collectibles catalog instead of that retrieved from the seller, and the rest of the information populated into the global collectibles database.

Not only does this module function, as already stated, to compare the first subject collectibles database and/or the global collectibles database to each other and/or one or more collectibles catalogs, but it can also function to create a second subject collectible database, a third subject collectible database or a subsequent subject collectible database. These databases are what the first subject collectible database would look like if a particular collectible were added or if a collectible in the database were upgraded and replaced. A collector is able to envision what his or her collection would be valued at or how it would rank in a list of other collectors sets easily and on the fly as collectibles become available to the market. In some embodiments, the collector may decide to just see what available collectibles would improve the set regardless of what individual item is being added. The comparison module will show the collector which collectibles will improve the collectors set and by how much, as compared with other additions.

A contemplated comparison module can also be set or directed by the collector based on the collector's resources. For example, the collector may indicate to the system that the collector: a) wants to improve his or her coin set A, and b) only has $10000 to spend. So in one embodiment, the collector will select coin set A from the Dashboard or the Collector's listing, click on “Improve My Set” and then select from the following options: “Find the Best Coin”, “Complete My Set”, “Improve My Set”, or “Use This Budget”. If the latter is selected, a prompt will ask the collector what the budget is—which in this case is $10000. The comparison module will work in conjunction with the search module, the report module and possibly the alert module to provide this information to the collector with respect to the current information in the global collectibles database and with respect to future information as it becomes available—in the global collectibles database.

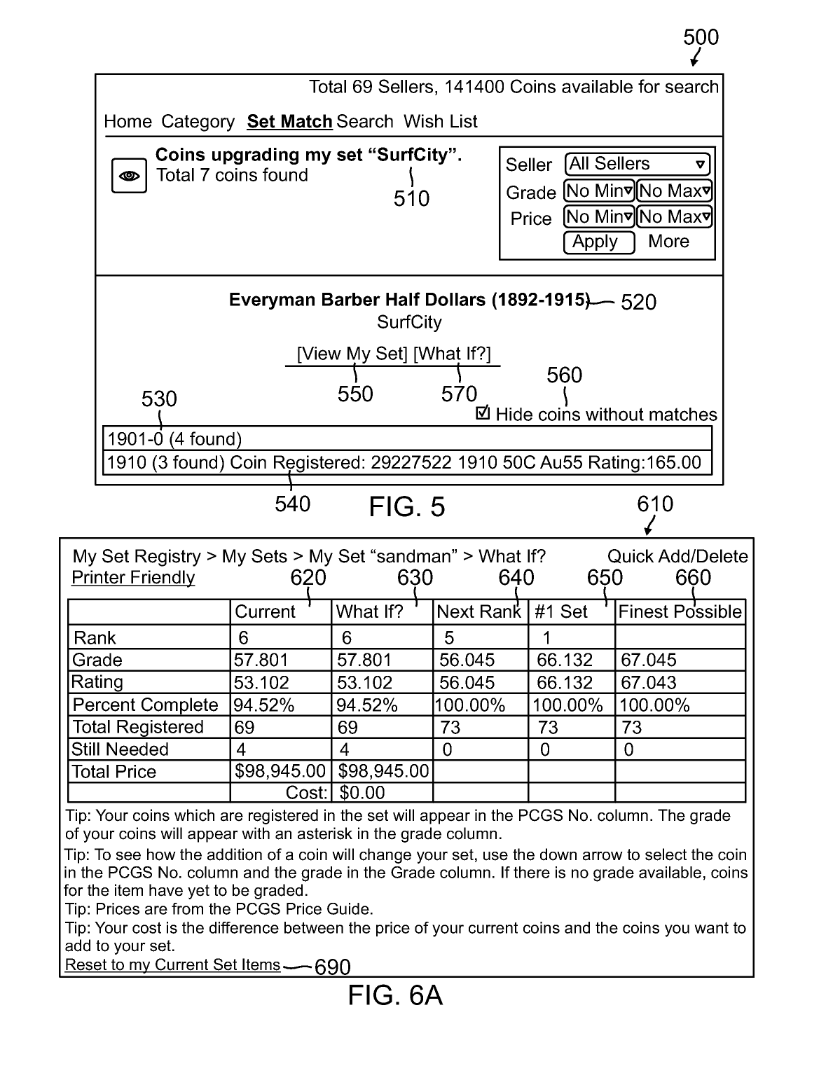

FIG. 5 shows a contemplated comparison module interface 500, wherein the user (not shown) is considering upgrading his or her set 510 with an Everyman Barber Half Dollar 520. The comparison module shows that four 1901-0 coins 530 were found and three 1910 coins 540 were found. The user is able to view each of these seven coins on their own and then “View My Set” 550 to see the current value of the user's set, what the set would be valued at if each one of the seven coins were added to the user's set or used to replace a lesser valued coin in the user's set, and how the user's set compares to other user's sets. Coins that are in the Collectibles Catalog but not found in the Global Collectibles Database can be hidden by selecting the “Hide Coins Without Matches” link 560, because collectors may not be interested in seeing coins that are not available for acquisition. The “What If” 570 link allows the user to view his or her set 510, if various coins are added to the set or used to replace lower value coins or collectibles in the set.

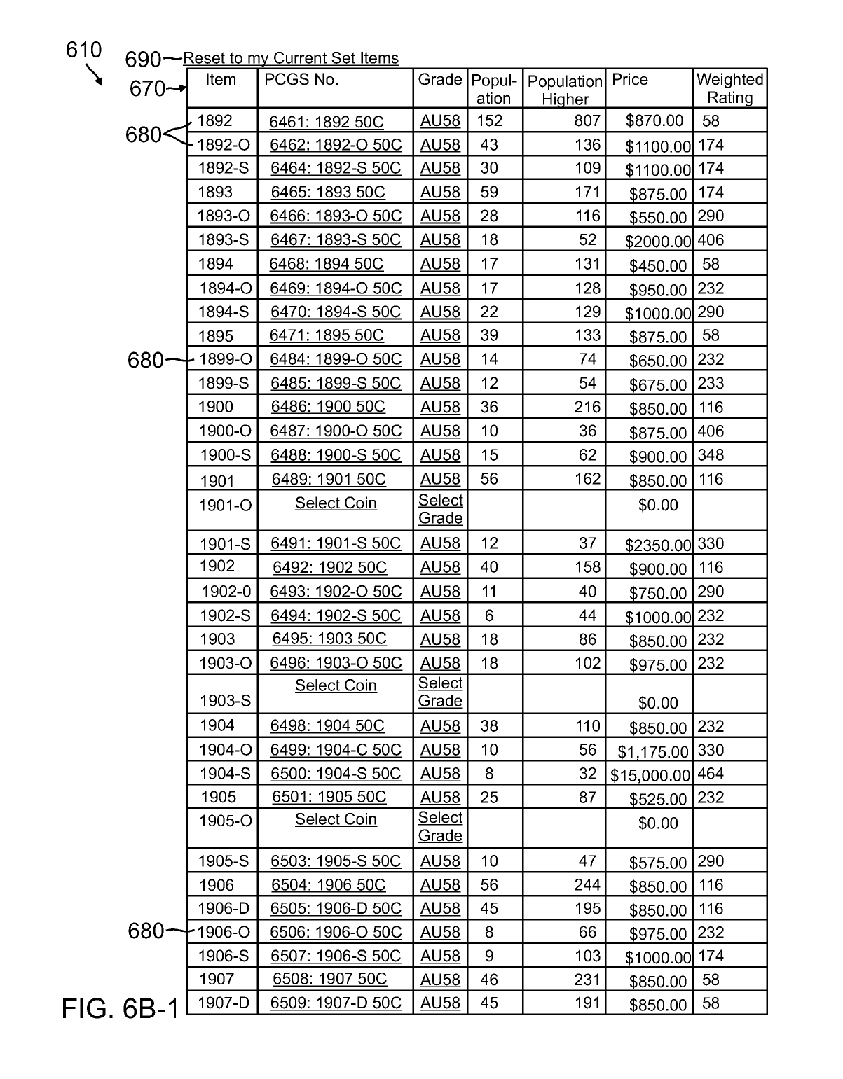

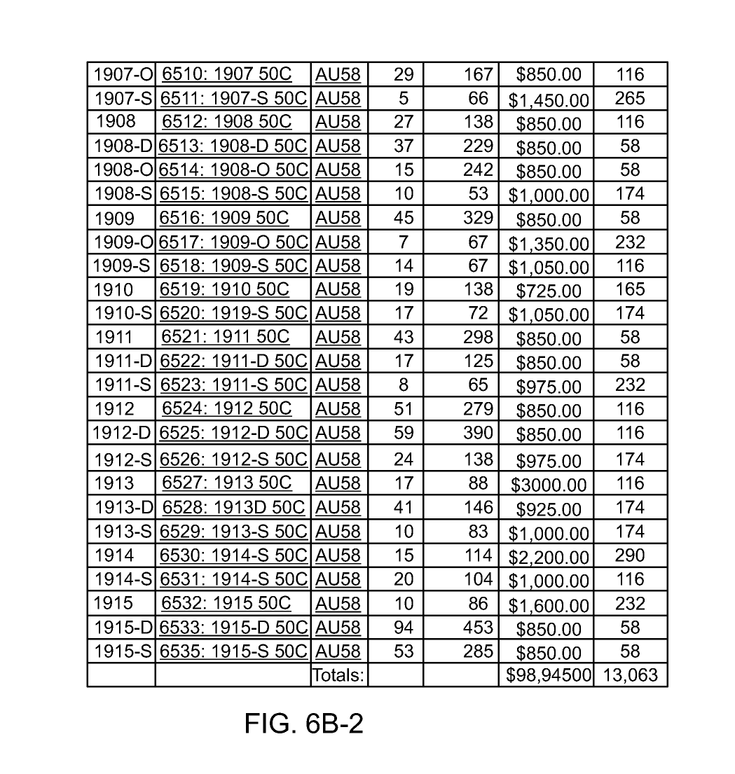

FIGS. 6A and 6B1-6B2 show an interface 610 where the user (not shown) can easily compare his or her Current set 620, with various other Ideal Sets, including “What If” 630, “Next Rank” 640, “#1 Set” 650 and “Finest Possible” 660. The list 670 below in FIGS. 6B1-6B2 allows the user to easily compare coins 680 on one webpage within the set, add coins to the set and reset back to the original set 690 on one page without viewing multiple websites and individual pages.

### Validation Module

A validation module may be used to further confirm the accuracy of the retrieved information used to populate the global collectibles database or the collectibles catalog. Exemplary features of the validation module have been described above with respect to the comparison module. These modules need not be separate components, but may be integrated or may share features. As described herein, a validation module may be used to retrieve additional information from the site or other location regarding the collectible for sale or auction, which may be used to provide additional information and/or accuracy to the originally retrieved information.

The validation module may be used if a conflict is determined from a comparison with the collectibles catalog as performed by the comparison module, described above. The validation module may also be used without a conflict to further confirm retrieved information or supplement the retrieved information. The validation module may therefore retrieve additional information from the seller site or independent location and analyze the additional information for comparison to the originally retrieved information.

In an exemplary embodiment, the validation module may be used to retrieve additional information about the collectible not available or supplied by the seller. For example, an image may be retrieved and analyzed to provide details about the collectible, such as certification or identification number that may not be supplied or captured by the seller.

In an exemplary embodiment, the additional retrieved information may be available characteristics for a given collectible. For example, if a collectible is identified for sale and the date is inconsistent with the information found in the collectibles catalog, the validation module may be used to retrieve the available dates for the description of the collectible provided for sale. The validation module may therefore use this additional information to determine if the retrieved date describing the collectible for sale is within the available range associated with that collectible.

In an exemplary embodiment, the additionally retrieved information may be an image of the collectible that is analyzed to recognize text or images. The recognized text may be used to determine characteristics of the collectible that may relate to the structured data fields of the global collectibles database. For example, an image of a coin in a holder may be analyzed to determine its date, denomination, certification or identification number, etc. This information as analyzed may be compared to the retrieved information from the host website that was entered as text to describe the collectible for sale. Therefore, if a seller provides inaccurate information, the correct information may be obtained through analysis of other provided details of the collectible including, for example, the image of the collectible.

The validation module may be used in the logic of the comparison and reporting module to determine what information should take priority and be stored in the global collectibles database or be presented to a collector. For example, if the retrieved information from a seller is invalid for that given characteristic of the collectible, then the retrieved information may not be saved in the global collectibles database, or the information may be modified either by information from the collectibles catalog or other known accurate source. In an exemplary embodiment, if the precise information is unknown, then general information can be supplied such that the collectible shows up in all search results relevant to the collector having criteria consistent with the other verified characteristics of the collectible for sale.

The validation module may also iteratively analyze the additionally retrieved information, such as an image, depending on the accuracy of the retrieved information and the accuracy of the previous comparisons. For example, an image may be quickly analyzed (such as by using lower resolution recognition) or select portions of an image analyzed to identify possible additional information. If the additional information is retrieved and verified against either the originally retrieved information and/or the collectibles catalog, then the validation module may stop and the correct information entered into the global collectibles database. However, if the low resolution, or selectively located image analysis was insufficient to retrieve additional information or was found to be inconsistent with either the originally retrieved information or the collectibles catalog, another analysis may be performed, such as using higher resolution image decomposition, different analysis logic, or an analysis over more or all of the image.

### Search and Report Modules

The module that elevates most of these databases, modules and embodiments to a level that is currently unavailable is the search module, alone or in combination with the reporting module. A contemplated search module combs the internet for available collectibles, whether they are for sale, for auction or offered in trade. The search module is then operatively connected to the reporting module, which takes all of the information gathered by the search module, standardizes it for display and reports it to the consumer in one, easy to read, easy to compare report. The results of the search module and reporting modules can be found throughout the Figures, including FIGS. 3, 5, 6 and 7.

To date, collectors were left with a standard google.com, yahoo.com or Bing search that pulls back everything related to a collectible. Contemplated search modules can be configurable for a dealer site, vendor site, auction site or trade show site. Contemplated modules are designed to read the available inventory or available auction items. The searching module may be designed so that it increases the frequency of updates to the collector as an auction for a particular collectible approaches close.

The search module may be used to retrieve information from two or more different sources about available collectibles for purchase. The search module may include a general search component and one or more configured search components. The general search component may be used to identify sites containing information for inclusion in the global collectibles database. Once identified, a configured search component may be configured to retrieve information from the site and correlate the retrieved information with the structured data fields of the global collectibles database. Therefore, one or more configured search components may be configured for each identified site and specifically configured to retrieve select information from the site and correlate the retrieved information to specific structured data fields of the global collectibles database. The general search component may also be configured to retrieve information from a site, such as images, text, etc. The retrieved information may be stored in substantially the same form as it is retrieved within the global collectibles database or may be processed to determine a correlation between the retrieved information to a structured data field of the global collectibles database.

For example, if a collector searched “Albert Pujols Topps rookie card”, a conventional search would pull back places that currently sell the card, did sell the card, old auctions, articles about Albert Pujols, Topps, etc. Contemplated search modules are specifically designed to only retrieve information where an Albert Pujols Topps rookie card is currently being sold, offered or auctioned and a contemplated reporting module collects that information and presents it to the collector in a concise, standardized and easy to interpret way. The collector can then compare the information quickly without having to spend hours going from site to site to determine if the collectible is available and if the information is accurate. Alert Module (“The Intelligent Agent”)

One additional and contemplated module is an alert module, which is another unique facet of contemplated embodiments. The alert module can also be referred to as the “intelligent agent”, because it's “job” is to work as an agent for the user to collect information as it comes into the global collectibles database.

The alert module works in conjunction with the comparison module, the search module and the reporting module to provide collectors with a way to “watch for” certain collectibles entering the available market, price changes on targeted collectibles or better quality collectibles coming on to the available market. Once the collector identifies items to watch for or parameters to search for, the alert module will send a text, E-mail or another suitable alert to the collector once an item has been located or conditions have changed for identified collectibles.

In some instances where a particular item is up for bid at an auction, the user may set up an alert to notify him or her when the item is in the last 5 minutes (or a predetermined time window) of the auction, if his or her bid has been exceeded or if the price has reached a certain amount.

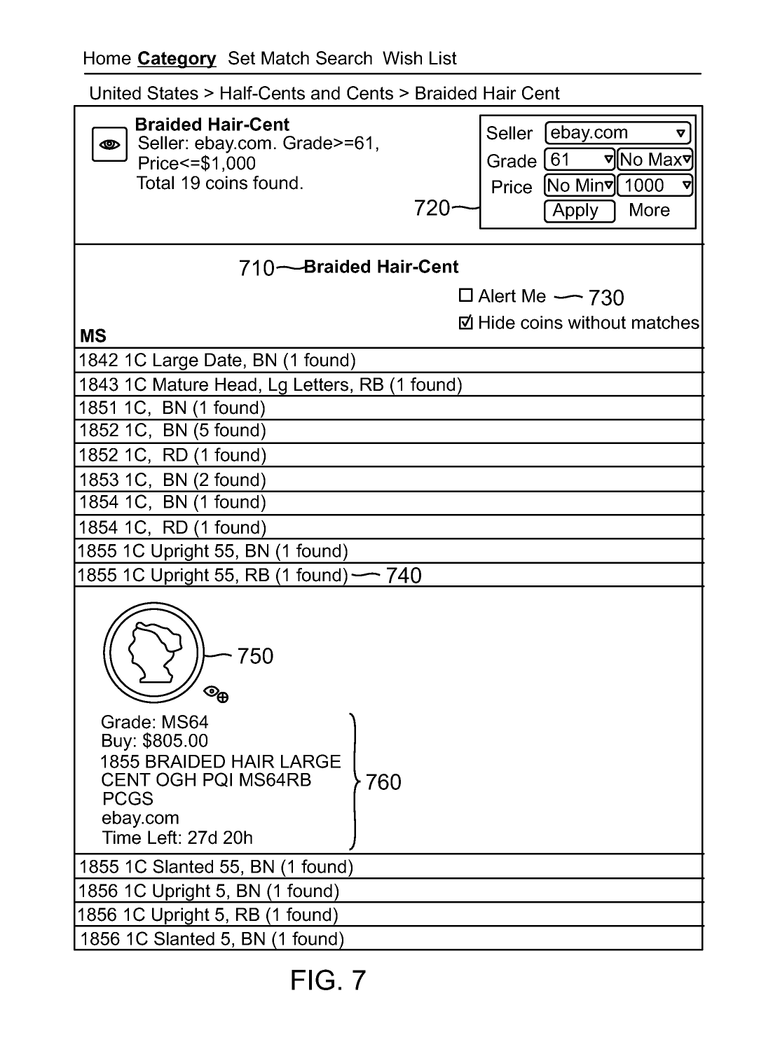

One aspect of the Alert Module is shown in FIG. 7 and allows the user to set parameters and standards for a particular collectible. In FIG. 7, the Braided Hair Cent page 710 is shown. In the top right corner of the page, the user (not shown) can use the window 720 to narrow down the seller, the grade and the price. And while this window can be used as a sort feature, the user can also set alerts and notifications from this window. For example, the user can set a grade and/or a price and click on “Alert Me” 730, and when Braided Hair Coins of that grade and/or price come into the Global Collectibles Database, the user is notified. This Alert does not appear under the “Coins I'm Watching”, but instead appears under the Alert Module feature and related icon. It should be noted on this page as well that the user has clicked on the 1855 1C Upright, 740, where one was found, and has pulled up the digital image 750 and detailed information 760 without leaving the page 710.

The user can also set up the alert module to provide an alert any time that any collectible comes on to the market that will make the collector's set better or more valuable. This feature is critical for collectors, in that they can set this feature and walk away, thus leaving the “intelligent agent” to recognize new items in the global collectibles database, compare those items with the collector's set or sets, determine if the new collectible will make the collector's set better—and if so, notify the collector with an alert as to the item, the vendor/dealer, the price and the estimated value increase to the collector's set or sets.

### Sales Module

Once the collector has all of the information in front of him or her, as to available collectibles, the condition and cost of those collectibles and how those collectibles will change the value of the first subject collectible database, the collector can use a contemplated sales module to acquire the collectible, if desired. The sales module will also allow the collector to list individual items in his or her collection. For example, if the collector upgrades his collection by adding a better quality coin, the already-owned lower quality coin may be then listed for sale by the collector. The sales module will also allow the user to buy the coin directly from the detailed listing on the page, if desired.

### The Online and Mobile Dashboard

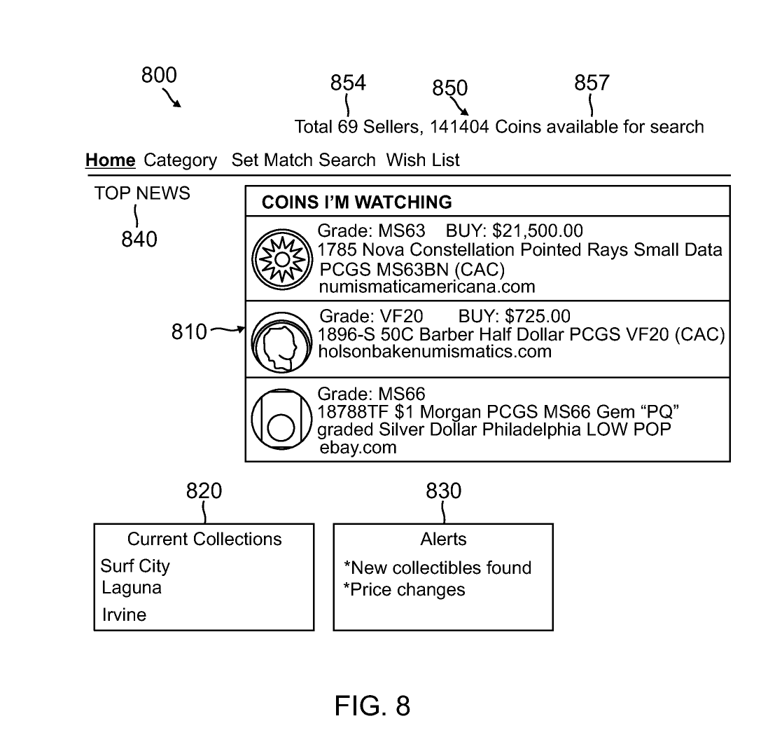

It is contemplated that all of the contemplated databases and modules can be easily and simply represented on the user's online and mobile dashboard. The Dashboard 800, as shown in FIG. 8, may show a number of contemplated features, including “Coins I'm Watching” 810, which is a simple list of the coins that the user is keeping an eye on for some reason. The user may want to see if their prices drop or change, may want to consider buying them at a later date or may want to save the information to call the dealer. A contemplated dashboard may also provide links to the user's current collections 820, so that they are easily accessible from one place. A contemplated dashboard may also provide alert notices 830, an interface to the sales module, a running ticker of online news 840 and alerts related to the user's collections and preferences, and a number of other pieces of information. It is also contemplated that the online and mobile dashboard can be set up according to each user's preferences and what he or she wants to see when it is accessed. The “Coins I'm Watching” feature may be at the top of the page or the bottom of the page. In other words, this Dashboard is configurable from a number of available options. Another piece of information contemplated systems provide is a summary of the Global Collectibles Database 850, that shows the number of sellers 854 and the coins available for search 857.

The Dashboard 800, as shown in FIG. 8, may show a number of contemplated features, including “Coins I'm Watching” 810, which is a simple list of the coins that the user is keeping an eye on for some reason.

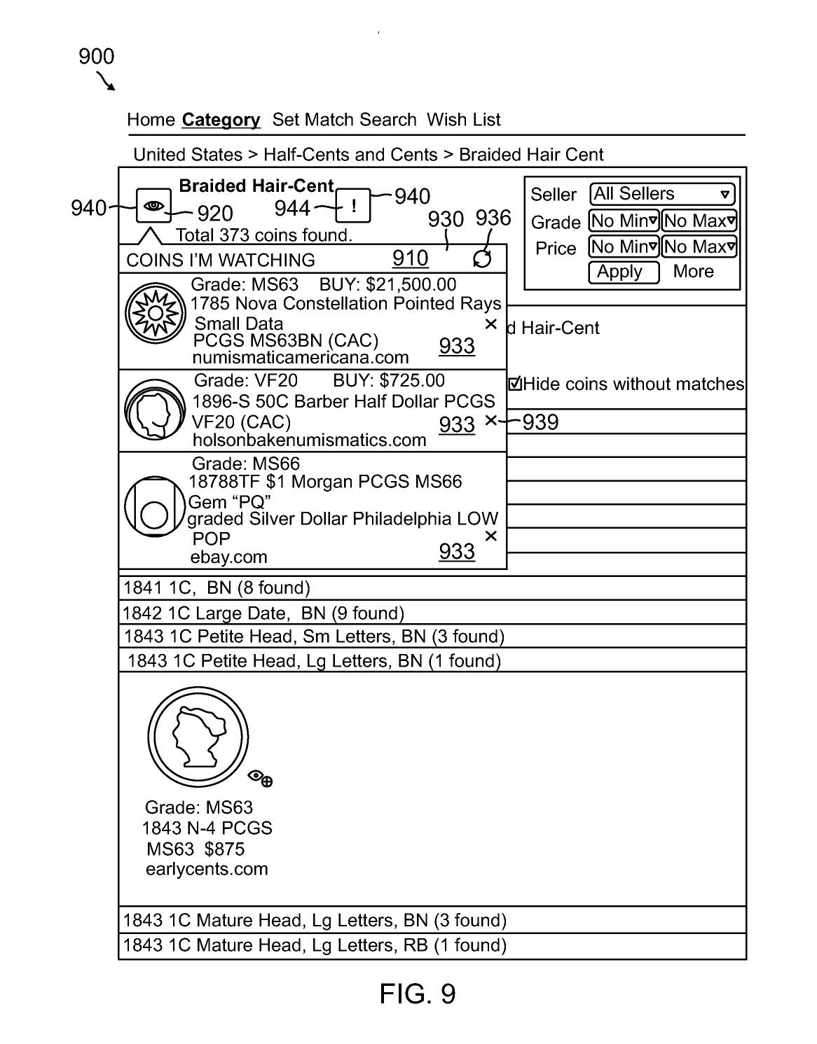

It is also contemplated that various aspects of the Online and Mobile Dashboard can be accessed immediately as the user is using the various features of the overage marketplace. As shown in FIG. 9, the user is accessing the global collectibles database page 900 and wants to quickly view the “Coins I'm Watching” 910. All the user has to do is click on the icon 920 at the top of the page and a pop-up window 930 opens that shows these coins 933, along with a refresh 936 option and a delete option 939. Each of these items in the pop-up window are also accessible by clicking on the link associated with the item. In addition, the user can set up a number of icons 940 to “follow” the user around from page to page, including notifications or alerts 944.

As shown in FIG. 9, the user is accessing the global collectibles database page 900 and wants to quickly view the “Coins I'm Watching” 910. All the user has to do is click on the icon 920 at the top of the page and a pop-up window 930 opens that shows these coins 933, along with a refresh 936 option and a delete option 939. Each of these items in the pop-up window are also accessible by clicking on the link associated with the item. In addition, the user can set up a number of icons 940 to “follow” the user around from page to page, including notifications or alerts 944.

As mentioned, a separate online collectible marketplace, which may act as a companion or component to the system for acquiring and managing collectibles or may be independent from that system, is contemplated and comprises: a global collectibles database comprising information from at least two different sources, a collectibles catalog and a search module. This contemplated embodiment is designed for a new collector or for someone who is just trying to search for a specific collectible irrespective of his or her personal collection. The contemplated global database comprises information from at least two different sources, which may be two different vendors, a vendor and an auction site, a trade show and another vendor or a combination of these. It should be understood that while the global collectibles database comprises information from at least two different sources, that doesn't mean that every collectible has at least two different listings. In some embodiments and with some collectibles, there may only be one available from only one of the sources. If that is the case, that is the information presented to the collector.

The Dashboard, along with other pages throughout contemplated embodiments, can be designed to highlight preferred sellers, high volume dealers, and dealers or coins where there is a high value of confidence in the quality of the coins or the professionalism of the dealer/vendor.

The Dashboard may also be set up and communicated in app form on a smartphone, tablet or laptop. In these embodiments, the user can set up preferences and layout as well, and that layout may be different than the one found on the user's internet profile or layout.

Systems and methods disclosed herein advance the collector's ability not only to review online databases and collectible grades, but compare collectibles from multiple sites and dealers, compare with collectibles in the collector's current sets, suggest upgrades to the collector based on what is available on the market, and set up an alert system that will alert a collector when a collectible becomes available on the market.

### Online Collectible Marketplace

A separate online collectible marketplace 190, which is shown enclosed by the dashed line in FIG. 1 and which may act as a companion or component to the system for acquiring and managing collectibles or may be independent from that system, comprises: a global collectibles database comprising information from at least two different sources, a collectibles catalog and a search module. Additional modules, such as the report and alert modules, are contemplated and can be utilized with the online collectible marketplace.

It should be understood that contemplated embodiments comprise a global collectibles database, as disclosed herein. However, the information provided to the global collectibles database comes from at least two different sources, wherein a source may be a vendor, dealer, auction house, collector or another source. The phrase “at least two different sources” may mean that the database comprises information from two different vendors, a vendor and a dealer, a collector and an auction house or two different collectors, for example.

A contemplated online collectible marketplace is designed to not only search a collectibles catalog, but also a global collectibles database (what is actually available) and reports this information to the user/collector.

### Contemplated Displays and Systems

As described herein, contemplated embodiments can be stored on, executed from or accessed from a central server, network server, a central Cloud or another multi-user accessible and/or two-way system. In some embodiments, a contemplated handheld device, portable device or combination thereof may comprise a software “app” that is designed to access the Global Collectibles Database, the First Subject Collectibles Database, the Dashboard and any other piece of the contemplated system in order to present the user with a completely mobile, completely accessible system and Dashboard.

As part of these systems, a display device may be included that comprises a digital display, an interactive display with keyboard (actual, digital or voice recognition-enabled), a combination digital and paper artwork display or a combination thereof Contemplated collectibles systems are designed to and have components that allow them to communicate with the handheld device, portable device or combination thereof.

Contemplated systems may also comprise a user-utilized handheld device, portable device or combination thereof. Contemplated devices may include a smart phone, hand held device, laptop computer or another suitable device with a network connection, data transfer connection, network data connection, cellular data network and/or connection, Wi-Fi connection, or another suitable device/link combination or connection that allows the user to communicate with contemplated collectibles systems, as disclosed herein.

Contemplated systems embodiments and related applications or apps are saved on, executed on, stored on or located on a portable media storage device, a hand held device, a tablet computer, a laptop computer, a desk top computer, a network server, an internet server, the cloud or a combination thereof.

Exemplary databases, modules, and interfaces are shown and described herein. These features may be used in any combination, separating, duplicated, combined, removed, or added in any combination to achieve the desired function and remain within the scope of the invention. For example, the search module and global collectibles database may be used in conjunction with the collectible catalog only, and without the first subject collectibles database. Functions or features described with respect to one module or database may be incorporated, shared, integrated, or removed from any module or database and/or incorporated into any other module or database. Other features, such as the alert module, sales module, dashboard, marketplace, etc. may be optional features.

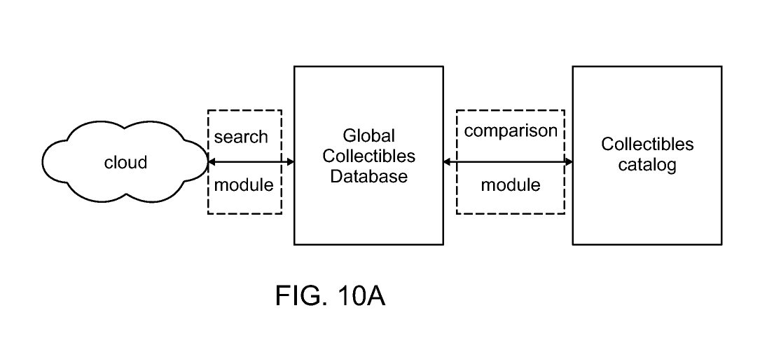

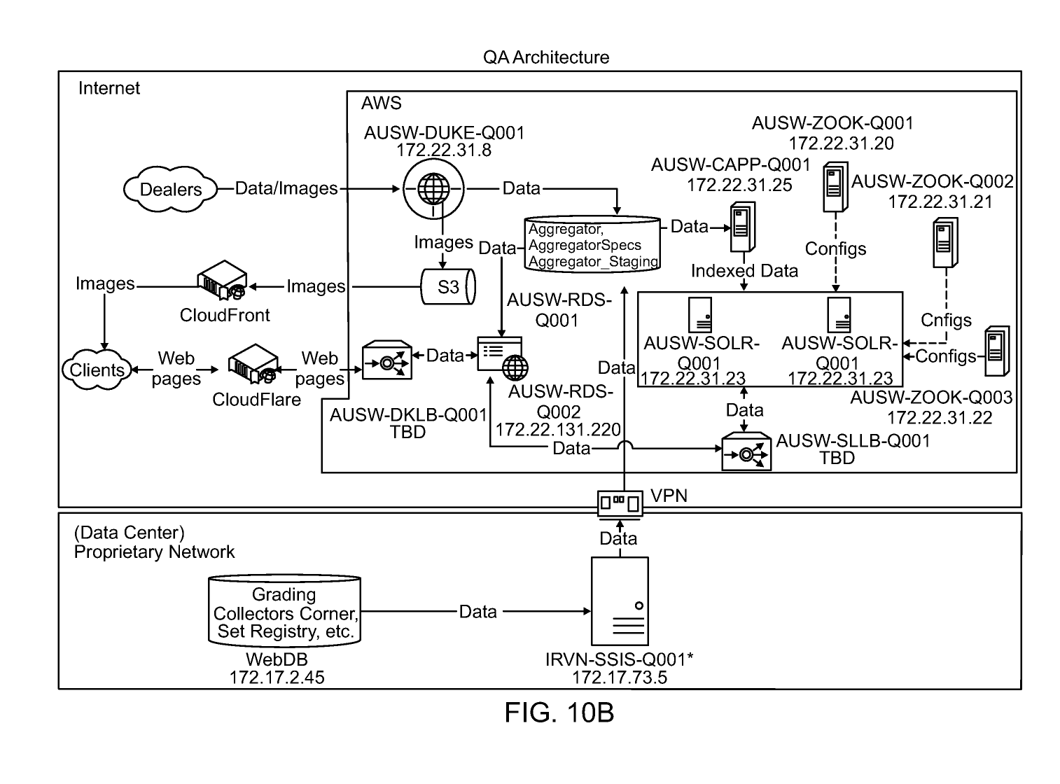

FIG. 10A illustrates an exemplary high level configuration of the network, global collectibles database, and collectibles catalog, while FIG. 10B illustrates an exemplary architecture to support the disclosed system. As described herein databases may be any memory structure to store information as described. The databases include memory structures in which information may be read or written to memory in a computer. The modules and systems may include hardware and software that when execute accomplish the functions as described herein. The software may include non-transitory machine readable medium stored in memory that, when executed by a processor, perform the functions described herein. The databases and modules described herein are not meant to be physical constructs requiring a single hardware of physical location. Instead, these constructs may occur across one or more computers, servers, networks, etc.

### Example System

A first exemplary system for aggregating, comparing, and acquiring collectibles is provided comprising a global collectible database, collectible catalog, comparison module, and search module. The search module may be used to retrieve information from two or more different sources about available collectibles for purchase. The collectibles catalog comprises structured data fields describing uniquely identifiable collectibles in existence. The comparison module may be used to populate the global collectible database with the results of the search module and information contained in the collectible catalog.

The search module is used to retrieve information from two or more different sources about available collectibles for purchase. In this example, the search module comprises a general search component made to retrieve information. The retrieved information is analyzed and compared to the collectibles catalog with the comparison module to correlate the retrieved information with the structured data fields of the global collectibles database.

For example, an image of a collectible is retrieved from a site and analyzed to recognize text. Part of the retrieved text is then identified as a grader's identification number. The grader's identification number is one of the structured data fields of the collectibles catalog and searched to retrieve other information about the collectible from the site. Other retrieved information from the site may be analyzed to determine which portion of the retrieved information correlates to specific structured data fields of the global collectibles database. Therefore, if the grader's identification number is found in the collectibles catalog and relates to a coin, then the retrieved information may be analyzed to find descriptions corresponding to the structured data fields of a coin collectible. Alternatively, or in addition thereto, the image may be processed to determine the type of collectible displayed. The image may then be selectively analyzed or the logic of the analyzer may be selected based on the type of collectible. The page is then searched for denomination, date, variety, etc. The retrieved information as correlated to structured data fields is then used to populate the global collectibles database.

The retrieved information as correlated to structured data fields is also compared for accuracy to further confirm the identified collectible is a legitimate sale or to correct or supplement information retrieved from the site. For example, once information is retrieved that is determined to relate to at least two of the structured data fields, including, for example, the date, denomination, grading identification, and variety, the retrieved information is compared to the collectibles catalog for confirmation that each retrieved information exist together in one entry of the collectibles catalog. If the retrieved information corresponding to two or more of the structured data fields of the collectibles catalog are confirmed as accurate, then the retrieved information is used to populate the global collectibles database. If a discrepancy is found in the retrieved information, a set of logic rules is used to either: modify the information with corrected information and enter modified information in the global collectibles database, enter the information without modification in the global collectibles database, not enter the information in the global collectibles database, provide an alert or notice that the information should be verified before or after inclusion in the global collectibles database, and any combination thereof. Even if a discrepancy is not found, the retrieved information may include gaps as compared to the structured data fields of the global collectibles database that are supplied by information stored in the collectibles catalog for the given collectible.

Once the information is stored in the global collectibles database, the report module is used to display all or a desired subset of available sales to a collector. The report module is configured to permit the collector to free form text search or select categories of results from a hierarchy of options correlating to the structured data fields. The collector may therefore find a more accurate and complete compilation of available items for sale specific to the characteristics relevant to the given collectible.

### Example System

A second exemplary system for aggregating, comparing, and acquiring collectibles is provided comprising a global collectible database, collectible catalog, comparison module, and search module. The search module may be used to retrieve information from two or more different sources about available collectibles for purchase. The collectibles catalog comprises structured data fields describing uniquely identifiable collectibles in existence. The comparison module may be used to populate the global collectible database with the results of the search module and information contained in the collectible catalog. The search and comparison modules may also be used to build and supplement the collectibles catalog.

The search module is used to retrieve information from two or more different sources about available collectibles for purchase. In this example, the search module comprises a general search component and one or more configured search components. The general search component is configured to identify sites having collectibles for sale or auction. Once identified, a configured search component is made to retrieve information from the site and correlate the retrieved information with the structured data fields of the global collectibles database.

For example, once the general search component identifies a site or once a site is otherwise known to the system architect, at least one configured search component is created for that site. The configured search component is configured to retrieve specific information from the site and correlates the information to structured data fields of the global collectibles database.

Once the configured search component retrieves information from a new posting from the site, the comparison module is used to validate and supplement the retrieved information before inclusion in the global collectibles database. The retrieved information is first analyzed for accuracy. Therefore, the different available pieces of retrieved information are compared to the corresponding structured data fields of the collectibles catalog to confirm the accuracy of the information. Similar to example 1, a set of logic rules can be imposed to determine whether the information is sufficiently accurate, and what to do in the event the information is inaccurate. Once verified, the retrieved information is stored in the global collectibles database. Missing information corresponding to unmapped structured data fields are then supplemented or filled with information retrieved from the collectibles catalog.

The direct mapping of retrieved information to structured data fields by the structured search component permits the system to build the collectibles catalog. In this case, if a comparison is made from the retrieved information to the collectibles catalog, and none of the information is found in the catalog, a new catalog entry may be made. Before entering information into the catalog, the system may confirm the accuracy from outside or general information known about the collectible, other collectibles identified in the collectibles catalog, and/or whether the retrieved information is internally consistent. For example, before entering in a new collectible in the collectibles catalog, the information may be analyzed to determine that the retrieved information corresponding to each of the structured data fields are available in the provided combination, exist in other collectibles, or are available through a separate search or comparison to another database or source. Therefore, retrieved information about a coin that has a denomination and variety that does not match a known available date will not be entered into the collectibles catalog. The level of accuracy necessary before information is entered into the collectibles catalog may be the same or higher than the level of accuracy necessary for entering information into the global collectibles database. Therefore, previous search results may be used to compare and validate later search results as stored in the collectibles catalog.

Similar to example 1, once the information is stored in the global collectibles database, the report module is used to display all or a desired subset of available sales to a collector.

Thus, specific embodiments and systems for aggregating, comparing and acquiring collectibles, methods and uses thereof, including comparing and valuing complete or incomplete sets of collectibles with respect to other individual collectibles or other sets of collectibles have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A system for acquiring and managing collectibles, comprising:
a global collectibles database comprising a first set of structured data fields, the global collectibles database storing information about collectibles for sale;
a collectibles catalog comprising a second set of structured data fields, the collectibles catalog storing information about existing collectibles;
a comparison module, wherein the comparison module is operatively connected to the global collectibles database and the collectibles catalog;
a search module, wherein the search module is operatively connected to the global collectibles database, the search module configured to retrieve information related to collectibles for sale from a network to be stored in the global collectibles database; and
a reporting module, wherein the reporting module is operatively connected to the global collectibles database.

2. The system for acquiring and managing collectibles of claim 1, further comprising a first subject collectibles database comprising a third set of structured data fields, the first subject collectibles database storing information about select collectibles owned by an individual user collector.

3. The system for acquiring and managing collectibles of claim 2, wherein the first, second, and third set of structured data fields comprises two or more structured data fields in common, and the comparison module is configured to compare the retrieve information related to collectibles for sale to the collectibles catalog to identify a collectible for sale.

4. The system for acquiring and managing collectibles of claim 3, where the comparison module is configured to compare the global collectibles database and first subject collectibles database to identify collectibles for sale that are missing from the first subject collectibles database

5. The system for acquiring and managing collectibles of claim 1, wherein the system is configured to compare the retrieved information to the collectibles catalog to identify a specific existing collectible from the collectibles catalog for a retrieved collectible for sale from the retrieved information from the network.

6. The system for acquiring and managing collectibles of claim 5, wherein the system is configured to store a first piece of information in at least one of the structured data fields of the first set of structured data fields of the global collectibles database from a second piece of information in at least one of the structured data fields of the second set of structured data fields of the collectibles catalog.

7. The system for acquiring and managing collectibles of claim 6, wherein the system is configured to compare the retrieved information from the network and the collectibles catalog and determine an error in the description associated with a collectible for sale.

8. The system for acquiring and managing collectibles of claim 7, wherein the system is configured to replace or supplement the error with correct information from the collectibles catalog.

9. The system for acquiring and managing collectibles of claim 1, wherein the search module comprises two or more configured search modules, and each configured search module is configured to search a specific domain and retrieve information related to collectibles for sale, the configured search module configured to identify which structured data field of the global collectibles database relates to each piece of retrieved information of the collectibles for sale, and the network is the internet.

10. The system for acquiring and managing collectibles of claim 1, wherein the global collectibles database comprises information from at least two different vendors, auction sites, dealers, trade shows or a combination thereof.

11. An interactive collectible dashboard, comprising:
the system for acquiring and managing collectibles of claim 1,
a graphical interface that is operatively and communicatively connected to the system for acquiring and managing collectibles, wherein the graphical interface shows information from the comparison module, the search module, the reporting module or a combination thereof.

12. A method for acquiring and managing collectibles, comprising:
providing a global collectibles database comprising a first set of structured data fields, the global collectibles database storing information about collectibles for sale;
providing a search module, wherein the search module is operatively connected to the global collectibles database,
retrieving information related to collectibles for sale from a network to be stored in the global collectibles database with the search module;
providing a collectibles catalog comprising a second set of structured data fields,
storing information about existing collectibles in the collectibles catalog;
providing a comparison module, wherein the comparison module is operatively connected to the global collectibles database and the collectibles catalog;
providing a reporting module, wherein the reporting module is operatively connected to the global collectibles database.
automatically comparing retrieved information to the collectibles catalog to determine whether the retrieved information relates to a file in the collectibles catalog,
supplementing the retrieved information with additional information about a collectible for sale from the collectibles catalog;
storing the retrieved information and the additional information in the global collectibles database.

13. The method of claim 12, further comprising determining an error in the retrieved information based on a comparison of the retrieved information with the collectibles catalog, and replacing or supplementing the error with correct information from the collectibles catalog.

14. The method of claim 12, further comprising:
providing a first subject database comprising collectibles of an individual collector;
identifying desirable collectible upgrades, desirable collectible additions or a combination thereof; and
using the search module to selectively search the internet for the identified upgrades, additions or a combination thereof.

15. An application that is saved on and executed from a smartphone, a laptop, a computer, a network or a tablet, wherein the application operatively executes the method of claim 12.

16. The method of claim 12, wherein retrieving information related to collectibles for sale from a network to be stored in the global collectibles database with the search module, comprises:
configuring a search module to search a given domain for collectibles for sale and relating information contained on the domain to specific structured data fields of the global collectibles database.

17. The method of claim 12, further comprising validating the retrieved information with at least one other piece of information from a domain of the retrieved information.

18. The method of claim 17, wherein the at least one other piece of information is an image of a collectibles, and validating comprises processing the image to recognize an object of the image or text in the image.

19. The method of claim 17, further comprising validating the retrieved information with known valid options for the retrieved information for known collectibles.

20. The method of claim 12, further comprising permitting a user to perform a specific and structured search based on characteristics specific to a type of collectible, where the characteristics specific to the type of collectible relate to the structured data fields of the global collectibles database.
